(19) United States
(12) Patent Application Publication
(10) Pub. No.: US 2025/0105740 A1
(43) Pub. Date: Mar. 27, 2025

(54) POWER SUPPLY DEVICE AND PROGRAM

(71) Applicant: Murata Manufacturing Co., Ltd., Nagaokakyo-shi (JP)

(72) Inventor: Kenta FUJII, Nagaokakyo-shi (JP)

(73) Assignee: Murata Manufacturing Co., Ltd., Nagaokakyo-shi (JP)

(21) Appl. No.: 18/889,651

(22) Filed: Sep. 19, 2024

(30) Foreign Application Priority Data
Sep. 27, 2023 (JP) 2023-165967

(51) Int. Cl. H02M 3/158

(52) U.S. Cl. CPC H02M 3/158

(57) ABSTRACT

A power supply device includes an input terminal to which a direct-current power supply can be connected, an output terminal, a power converter circuit, a first switch placed between the input terminal and a power converter circuit, a second switch placed between the power converter circuit and the output terminal, and a controller configured to control the first switch and the second switch to switch between an on-state and an off-state. For cutting off an electrical connection between the input terminal and the output terminal, the controller is configured to switch the first switch into an off-state and thereafter switch the second switch into an off-state.

### CROSS-REFERENCE TO RELATED APPLICATION

The present application is based on and claims priority to Japanese patent application JP 2023-165967, filed Sep. 27, 2023. The entire disclosures of the above-identified application, including the specification, the drawings and the claims are incorporated herein by reference in their entirety.

### BACKGROUND

A power supply device may include a high-voltage battery, a low-voltage battery, and a DC-DC converter connected between the two batteries. The DC-DC converter has a step-down function of transmitting electric power of the high-voltage battery to the low-voltage battery and a step-up function of transmitting electric power of the low-voltage battery to the high-voltage battery.

Further, the power supply device may include two semiconductor switches to protect circuits and a voltage control unit to control the semiconductor switches. One of the two semiconductor switches is connected between the DC-DC converter and a terminal of the high-voltage battery on a high potential side. The other of the two semiconductor switches is connected between the DC-DC converter and a terminal of the low-voltage battery on a high potential side.

On condition that the high-voltage battery and the low-voltage battery are connected with interchange thereof with respect to the DC-DC converter, for instance, the voltage control unit switches one or both of the two semiconductor switches into off-state.

### SUMMARY

The present disclosure includes a power supply device including: an input terminal to which a direct-current power supply can be connected; an output terminal; a power converter circuit placed between the input terminal and the output terminal; a first switch placed between the input terminal and the power converter circuit; a second switch placed between the power converter circuit and the output terminal; and a controller configured to control the first switch and the second switch. The controller is configured to switch the first switch into off-state and thereafter switch the second switch into off-state.

Further, the present disclosure includes a non-transitory computer readable medium storing a program which when executed by a computer causes the computer to perform a method including: switching a first switch into off-state, the first switch being placed between an input terminal of a power supply device to which a direct-current power supply can be connected and a power converter circuit placed between the input terminal and an output terminal of the power supply device; and thereafter switching a second switch into off-state, the second switch being placed between the power converter circuit and the output terminal.

Upon cut-off of the electrical connection between the input terminal and the output terminal, a load on a switch can be curbed.

### BRIEF DESCRIPTION OF THE DRAWINGS

FIG. 1 is a circuit diagram of a power supply device;

FIG. 2 is a circuit diagram illustrating actions of the power supply device; and

FIG. 3 is a circuit diagram illustrating a comparative example of actions of a power supply device.

### DESCRIPTION OF THE EXEMPLARY EMBODIMENTS

In a power supply device disclosed in the Background, on a condition that a semiconductor switch is switched off during operation of the DC-DC converter, the semiconductor switch may be placed under a load.

One exemplary embodiment of a power supply device and a program

Hereinbelow, an exemplary embodiment of a power supply device and a program will be described.

### Power Supply Device

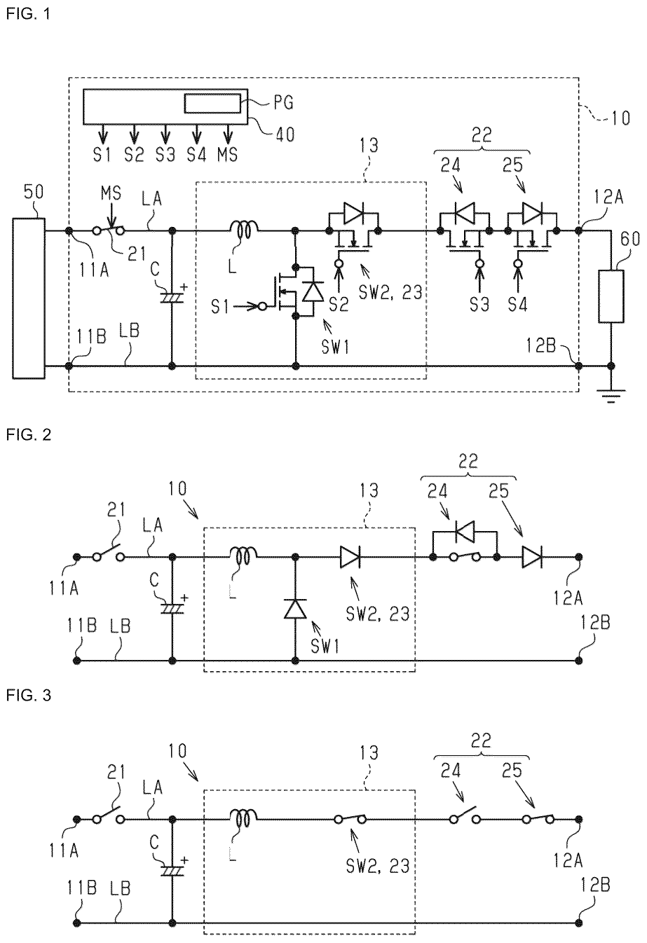

As illustrated in FIG. 1, a power supply device 10 includes a high-potential input terminal 11A, a low-potential input terminal 11B, a high-potential output terminal 12A, a low-potential output terminal 12B, a high-potential power-supply line LA, and a low-potential power-supply line LB.

A battery 50 as a direct-current power supply can be connected to the high-potential input terminal 11A and the low-potential input terminal 11B. Specifically, the high-potential input terminal 11A is connected to a positive terminal of the battery 50. The low-potential input terminal 11B is connected to a negative terminal of the battery 50. The battery 50 is a lithium-ion battery, for instance.

The high-potential output terminal 12A is connected to the high-potential input terminal 11A with the high-potential power-supply line LA interposed therebetween. The low-potential output terminal 12B is connected to the low-potential input terminal 11B with the low-potential power-supply line LB interposed therebetween. The high-potential output terminal 12A and the low-potential output terminal 12B can be connected to a load 60. The load 60 is operated by a direct-current voltage from the power supply device 10. The load 60 is a server or a storage of a data center or the like, for instance. Accordingly, electric power is supplied from the battery 50 to the load 60 with the input terminals, the power-supply lines, and the output terminals interposed therebetween. The low-potential output terminal 12B and the low-potential power-supply line LB have a ground potential.

The power supply device 10 includes an input capacitor C. The input capacitor C is an electrolytic capacitor. A positive terminal of the input capacitor C is connected to the high-potential input terminal 11A. A negative terminal of the input capacitor C is connected to the low-potential input terminal 11B.

The power supply device 10 includes a power converter circuit 13 placed between the input terminals and the output terminals. The power converter circuit 13 is positioned on the high-potential power-supply line LA and on the low-potential power-supply line LB. Specifically, the power converter circuit 13 includes an inductor L, a first switching element SW1, and a second switching element SW2. Each of the switching elements is a metal-oxide semiconductor field-effect transistor (MOSFET) of n-channel type. A first end of the inductor L is connected to the high-potential input terminal 11A. A source terminal of the first switching element SW1 is connected to the low-potential input terminal 11B and the low-potential output terminal 12B with the low-potential power-supply line LB interposed therebetween. A drain terminal of the first switching element SW1 is connected to a second end of the inductor L. A source terminal of the second switching element SW2 is connected to the second end of the inductor L and the drain terminal of the first switching element SW1. A drain terminal of the second switching element SW2 is connected to the high-potential output terminal 12A.

The power supply device 10 includes a first switch 21 and a second switch 22. The first switch 21 and the second switch 22 are both positioned on the high-potential power-supply line LA and can be switched into either of on-state and off-state.

The first switch 21 is placed between the high-potential input terminal 11A and the power converter circuit 13 on the high-potential power-supply line LA. Specifically, the first switch 21 is placed between the high-potential input terminal 11A and the first end of the inductor L. Accordingly, the source terminal of the second switching element SW2 of the power converter circuit 13 is connected to the first switch 21 with the inductor L interposed therebetween. In other words, the second switching element SW2 is a third switch 23 having a terminal of a body diode on an anode side connected to the first switch 21.

Though the first switch 21 is illustrated as a single-pole single-throw switch in the drawings, the first switch 21 is actually made of a plurality of switching elements. Specifically, the first switch 21 includes a plurality of bidirectional switches connected in parallel. The bidirectional switches are MOSFETs of n-channel type having source terminals connected to one another, for instance.

The off-state of the first switch 21 refers to a state in which the first switch 21 as a whole does not allow a current to flow from a side of the input terminals to a side of the output terminals and does not allow a current to flow from the side of the output terminals to the side of the input terminals, regardless of a combination of on-state and off-state of switch elements configuring the first switch 21.

The second switch 22 is placed between the power converter circuit 13 and the high-potential output terminal 12A on the high-potential power-supply line LA. Specifically, the second switch 22 is placed between the drain terminal of the second switching element SW2 of the power converter circuit 13 and the high-potential output terminal 12A.

The second switch 22 is a bidirectional switch. Specifically, the second switch 22 includes a fourth switch 24 connected to the power converter circuit 13 and a fifth switch 25 placed between the fourth switch 24 and the high-potential output terminal 12A. Both of the fourth switch 24 and the fifth switch 25 are MOSFETs of n-channel type. A drain terminal of the fourth switch 24 is connected to the drain terminal of the second switching element SW2. A source terminal of the fourth switch 24 is connected to a source terminal of the fifth switch 25. A drain terminal of the fifth switch 25 is connected to the high-potential output terminal 12A. Accordingly, the second switch 22 is made of the two MOSFETs of n-channel type having the source terminals connected to each other. In other words, the fourth switch 24 and the fifth switch 25 are serially connected so that terminals on anode sides of body diodes included therein are connected to each other. That is, the fourth switch 24 and the fifth switch 25 are connected so that orientations of the body diodes are opposite.

The off-state of the second switch 22 refers to a state in which the second switch 22 as a whole does not allow a current to flow from the side of the input terminals to the side of the output terminals and does not allow a current to flow from the side of the output terminals to the side of the input terminals, regardless of a combination of on-state and off-state of the fourth switch 24 and the fifth switch 25 configuring the second switch 22. That is, the off-state of the second switch 22 refers to a state in which the fourth switch 24 is off and in which the fifth switch 25 is also off.

As illustrated in FIG. 1, the power supply device 10 includes a control unit 40 to control the first switch 21, the second switch 22, and the third switch 23. The control unit 40 is capable of outputting control signals to switch on/off the switching elements included in the power converter circuit 13. Specifically, the control unit 40 outputs a first control signal S1 to switch on/off the first switching element SW1 of the power converter circuit 13. The control unit 40 outputs a second control signal S2 to switch on/off the second switching element SW2 of the power converter circuit 13.

The control unit 40 outputs control signals to switch the on-state and the off-state of the first switch 21. Specifically, the control unit 40 outputs a plurality of control signals MS corresponding to the switching elements configuring the first switch 21 and thereby switches on/off the switching elements individually.

The control unit 40 outputs control signals to switch the on-state and the off-state of the second switch 22. Specifically, the control unit 40 outputs a third control signal S3 to switch on/off the fourth switch 24. The control unit 40 outputs a fourth control signal S4 to switch on/off the fifth switch 25.

The control unit 40 includes a storage device and an arithmetic processing device. That is, the control unit 40 is a microcontroller unit (MCU). The storage device of the control unit 40 stores a program PG to be executed by the arithmetic processing device. The arithmetic processing device executes the program PG and thereby switches the on-state and the off-state of the switching elements included in the first switch 21, the second switch 22, and the power converter circuit 13 through switching control to be described later. The arithmetic processing device includes a central processing unit (CPU) or a micro processing unit (MPU), for instance.

### Switching Control

Subsequently, the switching control by the control unit 40 will be described. The switching control is control to switch the on-state and the off-state of the switches or the switching elements. The switching control is exercised through execution of the program PG, stored in the storage device of the control unit 40, by the arithmetic processing device.

The control unit 40 acquires an output voltage that is a potential difference between the output terminals while the power supply device 10 is driven. On a condition that the high-potential output terminal 12A and the low-potential output terminal 12B are short-circuited, for instance, the potential difference between the high-potential output terminal 12A and the low-potential output terminal 12B is decreased. When the potential difference between the output terminals becomes smaller than or equal to a predetermined threshold, the arithmetic processing device of the control unit 40 executes a series of switching control to cut off the electrical connection between the high-potential input terminal 11A and the high-potential output terminal 12A.

Upon a start of execution of the switching control based on the program PG, the control unit 40 initially switches the first switch 21 into the off-state. A period of time from the start of the execution of the switching control to switching of the first switch 21 into the off-state is shorter than 1 millisecond.

Subsequently, the control unit 40 switches the second switching element SW2 into the off-state among the switching elements of the power converter circuit 13. As described above, the second switching element SW2 is the third switch 23 having the terminal of the body diode on the anode side connected to the first switch 21. After that, the control unit 40 switches the fifth switch 25 into the off-state. A period of time from the switching of the first switch 21 into the off-state to switching of the second switching element SW2 into the off-state is shorter than 1 millisecond. A period of time from the switching of the second switching element SW2 into the off-state to switching of the fifth switch 25 into the off-state is shorter than 1 millisecond.

Subsequently, the control unit 40 switches the fourth switch 24 into the off-state. A period of time from the switching of the second switching element SW2 and the fifth switch 25 into the off-state to switching of the fourth switch 24 into the off-state is longer than the period of time from the switching of the first switch 21 into the off-state to the switching of the second switching element SW2 and the fifth switch 25 into the off-state. Specifically, the period of time from the switching of the second switching element SW2 and the fifth switch 25 into the off-state to the switching of the fourth switch 24 into the off-state is longer than or equal to 1 millisecond and shorter than 100 milliseconds. Upon the switching of the fourth switch 24 into the off-state, the switching control is ended.

In the switching control, in this manner, the control unit 40 switches the second switching element SW2 as the third switch 23 into the off-state after the switching of the first switch 21 into the off-state and before the switching of the second switch 22 into the off-state. Further, the control unit 40 switches the second switch 22 into the off-state by switching the fourth switch 24 into the off-state after switching the fifth switch 25 into the off-state.

### Action of Switching Control

For cutting off the electrical connection between the high-potential input terminal 11A and the high-potential output terminal 12A, the control unit 40 initially switches the first switch 21 into the off-state. Thus, a short current is prevented from flowing to the direct-current power supply such as the battery 50 connected to the input terminals. Electric energy is accumulated in the inductor L while the power supply device 10 is operated. On the other hand, the input capacitor C intervenes between the first switch 21 and the inductor L. Therefore, a current based on the energy accumulated in the inductor L is not conducted through the first switch 21 even if the first switch 21 is turned off.

Subsequently, as illustrated in FIG. 2, the control unit 40 switches the second switching element SW2 as the third switch 23 and the fifth switch 25 into the off-state. At this time, the body diode of the second switching element SW2 and the body diode of the fifth switch 25 allow flow of a current toward a side of the high-potential output terminal 12A. In FIG. 2, switching elements that are in off-state and that allow the flow of a current toward the side of the high-potential output terminal 12A are illustrated as diodes. Thus, the current based on the energy accumulated in the inductor L or the like flows through the body diode of the second switching element SW2 and the body diode of the fifth switch 25. That is, at least a portion of the energy accumulated in the inductor L is consumed by resistance of the body diodes of the switching elements.

Further, in the switching control, a specified period of time is provided after the switching of the second switching element SW2 and the fifth switch 25 into the off-state and before the switching of the fourth switch 24 into the off-state. Thus, a sufficient period of time for a current to flow through the body diode of the second switching element SW2 and the body diode of the fifth switch 25 is ensured.

Herein, it is assumed that only the fourth switch 24 is turned into the off-state after the first switch 21 is turned into the off-state, as illustrated in FIG. 3. At this time, the body diode of the fourth switch 24 does not allow a current to flow from the side of the input terminals to the side of the output terminals. That is, the energy accumulated in the inductor L is not consumed by the body diode of the second switching element SW2 and the body diode of the fifth switch 25.

### Exemplary Effects of Present Exemplary Embodiment

Some of the many effects of the exemplary embodiment are discussed below.
(1) In the exemplary embodiment, for cutting off the electrical connection between the input terminals and the output terminals, the control unit 40 switches the first switch 21 into the off-state and thereafter switches the second switch 22 into the off-state. On condition that electrical conduction between the input terminals and the output terminals is to be cut off in association with short circuit of an output terminal, for instance, the battery 50 can be protected against overcurrent by the initial switching of the first switch 21 into the off-state. Further, at least a portion of the energy accumulated in the inductor L or the like that configures the power supply device 10 is consumed by internal resistance of the second switch 22 or the like after the switching of the first switch 21 into the off-state and before the switching of the second switch 22 into the off-state. Therefore, the second switch 22 resists a large load that may be caused by action of the energy on the second switch 22 even if the second switch 22 is switched into the off-state. Further, occurrence of ringing is resisted when the second switch 22 is switched into the off-state.
(2) In the exemplary embodiment, the control unit 40 switches the first switch 21 into the off-state and thereafter switches the second switching element SW2 as the third switch 23 into the off-state. After that, the control unit 40 switches the second switch 22 into the off-state. At least a portion of the energy accumulated in such an element as the inductor L is consumed by the resistance of the body diode of the second switching element SW2. The load on the second switch 22 can be further reduced by subsequent turn-off of the second switch 22.
(3) In the exemplary embodiment, the second switch 22 is the bidirectional switch. Further, the control unit 40 switches the fifth switch 25 into the off-state and thereafter switches the fourth switch 24 into the off-state. The fifth switch 25 is switched into the off-state in advance, so that at least a portion of the energy accumulated in the inductor L or the like is consumed by the resistance of the body diode of the fifth switch 25. Therefore, the load on the second switch 22 as a whole can be reduced.
(4) In the exemplary embodiment, the control unit 40 switches the first switch 21 into the off-state and thereafter switches the second switching element SW2 and the fifth switch 25 into the off-state. After that, the fourth switch 24 is switched into the off-state. Thus, at least a portion of the energy accumulated in such an element as the inductor L is consumed by the resistance of the body diodes of the second switching element SW2 and the fifth switch 25. The load on the fourth switch 24 can be reduced by subsequent switching of the fourth switch 24 into the off-state.
(5) In the exemplary embodiment, the period of time from the switching of the second switching element SW2 and the fifth switch 25 into the off-state to the switching of the fourth switch 24 into the off-state is longer than the period of time from the switching of the first switch 21 into the off-state to the switching of the second switching element SW2 into the off-state. Thus, a period of time for consumption of the energy accumulated in such an element as the inductor L is produced. Therefore, the load on the second switch 22 can be reduced more remarkably.
(6) In the exemplary embodiment, the period of time from the switching of the second switching element SW2 and the fifth switch 25 into the off-state to the switching of the fourth switch 24 into the off-state is longer than or equal to 1 millisecond and shorter than 100 milliseconds. With ensuring of the period of time of this degree, almost all of the energy accumulated in such an element as the inductor L is consumed. Therefore, the load at time when the fourth switch 24 is turned into the off-state can be reduced remarkably. Further, on condition that the switching control is executed in confrontation with short circuit of the output terminals, influence of the short current is small, provided the period of time is of a degree not exceeding 100 milliseconds.
(7) In the exemplary embodiment, the first switch 21 is configured with a plurality of bidirectional switches connected in parallel. By contrast, the second switch 22 is the one bidirectional switch. Accordingly, on an assumption that loads having the same magnitude are exerted on the switches, the second switch 22 is greater in load exerted on one switching element configuring each of the switches. According to the exemplary embodiment, the second switch 22 is made to resist receiving a large load by the switching of the second switch 22 into the off-state after the switching of the first switch 21 into the off-state. That is, such a circuit configuration is desirable for application of the switching control. Further, an element having a comparatively small tolerance can be employed as the switching element configuring the second switch 22. That is, a larger number of types of elements are made selectable as the switching element configuring the second switch 22.

### Modifications

The above exemplary embodiment and following modifications may be implemented in combination to an extent that does not incur a technical contradiction.

A configuration of the power supply device 10 is not limited to an example of the exemplary embodiment as long as the first switch 21, the second switch 22, the power converter circuit 13, and the control unit 40 capable of executing the switching control over the switches are included therein. A type of the power supply connected to the input terminals, parameters such as voltage, a type of the load connected to the output terminals, or the like may be modified appropriately in accordance with application of the power supply device 10 or the like.

The power supply connected to the input terminals may be other than the battery 50 as long as the power supply is a direct-current power supply.

A configuration of the power converter circuit 13 is not limited to the example of the exemplary embodiment. For instance, a configuration in which a plurality of step-up converters are connected in parallel may be employed. A step-down converter may be used in place of the step-up converter. Further, in these configurations, the third switch 23 is not limited to the second switching element SW2 in the exemplary embodiment. A switching element having a terminal of a body diode on an anode side connected to the first switch 21 may be used as the third switch 23.

A configuration of the first switch 21 and a configuration of the second switch 22 are not limited to the configurations of the exemplary embodiment as long as switching thereof into the on-state or the off-state can be carried out by the control unit 40. For instance, one bidirectional switch may be used or a bipolar transistor may be used.

It is sufficient if the control unit 40 is capable of switching between the on-state and the off-state at least for the first switch 21 and the second switch 22. Further, the control unit 40 is not limited to the control unit made of one MCU. That is, an MCU to control the first switch 21 and an MCU to control the second switch 22 may be separately configured as different chips.

In the switching control, it is sufficient if the control unit 40 is capable of switching the second switch 22 into the off-state at least after switching the first switch 21 into the off-state. For instance, the third switch 23 may be turned into the off-state immediately before the first switch 21 is switched into the off-state. Further, the third switch 23 may be turned into the off-state after the second switch 22 is switched into the off-state. In these configurations as well, the load on the second switch 22 can be curbed when the second switch 22 is switched into the off-state.

The control unit 40 may switch the second switch 22 into the off-state by switching the fifth switch 25 into the off-state after switching the fourth switch 24 into the off-state. The control unit 40 switches the first switch 21 into the off-state and thereafter turns off the third switch 23, for instance. Subsequently, after lapse of a specified period of time, the fifth switch 25 may be switched into the off-state after the fourth switch 24 is switched into the off-state. In this configuration as well, a portion of the energy accumulated in the inductor L or the like is consumed by the body diode of the third switch 23. That is, the load on the second switch 22 can be curbed.

The control unit 40 may switch the third switch 23 into the off-state after switching the second switch 22 into the off-state. In the switching control, for instance, the first switch 21 is switched into the off-state and the fifth switch 25 is thereafter switched into the off-state. Subsequently, after lapse of a specified period of time, the third switch 23 may be switched into the off-state after the fourth switch 24 is switched into the off-state. In this configuration as well, a portion of the energy accumulated in the inductor L or the like is consumed by the body diode of the fifth switch 25. That is, the loads on the fourth switch 24 and the third switch 23 can be reduced.

In the switching control, sequence of timing when the third switch 23 is turned off and timing when the fifth switch 25 is turned off does not matter. That is, the timing may be substantially simultaneous or the fifth switch 25 may be turned off before the third switch 23 is turned off. This is because the energy accumulated in the inductor L or the like is consumed by the body diodes of the switching elements and the switches in both the configurations.

A period of time from the switching of the third switch 23 and the fifth switch 25 into the off-state to the switching of the fourth switch 24 into the off-state may be shorter than a period of time from the switching of the first switch 21 into the off-state to the switching of the third switch 23 and the fifth switch 25 into the off-state. In this configuration as well, the load on the second switch 22 can be curbed according to the switching control.

The period of time from the switching of the third switch 23 and the fifth switch 25 into the off-state to the switching of the fourth switch 24 into the off-state may be shorter than 1 millisecond or may be longer than or equal to 100 milliseconds. In these configurations as well, the load on the second switch 22 can be curbed according to the switching control. On condition that a time difference shorter than 1 millisecond is provided so as to precede turn-off of the third switch 23 and the fifth switch 25, for instance, the load on the second switch 22 can be curbed compared with a configuration not provided with the period of time.

### Supplementary Note

Technological thoughts that can be derived from the exemplary embodiment and the modifications will be described below.
[1]

A power supply device including:
an input terminal to which a direct-current power supply can be connected;
an output terminal;
a power converter circuit placed between the input terminal and the output terminal;
a first switch placed between the input terminal and the power converter circuit;
a second switch placed between the power converter circuit and the output terminal; and
a control unit to control the first switch and the second switch, in which
for cutting off electrical connection between the input terminal and the output terminal, the control unit switches the first switch into off-state and thereafter switches the second switch into off-state.
[2]

The power supply device according to [1], in which
the power converter circuit includes a third switch having a terminal of a body diode on an anode side connected to the first switch, and
the control unit is capable of controlling the third switch and, for cutting off the electrical connection between the input terminal and the output terminal, switches the third switch into off-state after switching the first switch into the off-state and before switching the second switch into the off-state.
[3]

The power supply device according to [1] or [2], in which
the second switch is a bidirectional switch including
   a fourth switch connected to the power converter circuit and including a body diode, and
   a fifth switch placed between the fourth switch and the output terminal and including a body diode,
the fourth switch and the fifth switch are serially connected so that terminals on anode sides of the body diodes included therein are connected to each other, and
the control unit switches the fifth switch into off-state and thereafter switches the fourth switch into off-state.
[4]

The power supply device according to [3], in which
the power converter circuit includes a third switch having a terminal of a body diode on an anode side connected to the first switch, and
the control unit is capable of controlling the third switch and, for cutting off the electrical connection between the input terminal and the output terminal, switches the first switch into the off-state, thereafter switches the third switch and the fifth switch into the off-state, and thereafter switches the fourth switch into the off-state.
[5]

The power supply device according to [4], in which
a period of time from switching of the third switch and the fifth switch into the off-state to switching of the fourth switch into the off-state is longer than a period of time from switching of the first switch into the off-state to the switching of the third switch and the fifth switch into the off-state.
[6]

The power supply device according to [5], in which
the period of time from the switching of the third switch and the fifth switch into the off-state to the switching of the fourth switch into the off-state is longer than or equal to 1 millisecond and shorter than 100 milliseconds.
[7]

A program to be applied to a power supply device including:
an input terminal to which a direct-current power supply can be connected;
an output terminal;
a power converter circuit placed between the input terminal and the output terminal;
a first switch placed between the input terminal and the power converter circuit;
a second switch placed between the power converter circuit and the output terminal; and
a control unit to control the first switch and the second switch, in which
for cutting off electrical connection between the input terminal and the output terminal, the program causes the control unit to execute a process of switching the first switch into off-state and thereafter switching the second switch into off-state.

What is claimed is:

1. A power supply device comprising:
an input terminal to which a direct-current power supply can be connected;
an output terminal;
a power converter circuit placed between the input terminal and the output terminal;
a first switch placed between the input terminal and the power converter circuit;
a second switch placed between the power converter circuit and the output terminal; and
a controller configured to control the first switch and the second switch, wherein
the controller is configured to switch the first switch into an off-state and thereafter switch the second switch into an off-state.

2. The power supply device according to claim 1, wherein
the power converter circuit includes a third switch having a terminal of a body diode on an anode side connected to the first switch, and
the controller is configured to switch the third switch into an off-state after switching the first switch into the off-state and before switching the second switch into the off-state.

3. The power supply device according to claim 1, wherein
the power converter circuit includes a third switch having a terminal of a body diode on an anode side connected to the first switch, and
the controller is configured to switch the second switch into the off-state after switching the first switch into the off-state and before switching the third switch into the off-state.

4. The power supply device according to claim 1, wherein
the power converter circuit includes a third switch having a terminal of a body diode on an anode side connected to the first switch, and
the controller is configured to switch the first switch into the off-state after switching the third switch into the off-state and before switching the second switch into the off-state.

5. The power supply device according to claim 1, wherein
the second switch is a bidirectional switch including
a fourth switch connected to the power converter circuit and including a body diode, and
a fifth switch placed between the fourth switch and the output terminal and including a body diode,
the fourth switch and the fifth switch are serially connected so that terminals on anode sides of the body diodes included therein are connected to each other, and
the controller is configured to switch the fifth switch into an off-state and thereafter switch the fourth switch into off-state.

6. The power supply device according to claim 5, wherein
the power converter circuit includes a third switch having a terminal of a body diode on an anode side connected to the first switch, and
the controller is configured to switch the first switch into the off-state, thereafter switch the third switch and the fifth switch into the off-state, and thereafter switch the fourth switch into the off-state.

7. The power supply device according to claim 5, wherein
the power converter circuit includes a third switch having a terminal of a body diode on an anode side connected to the first switch, and
the controller is configured to switch the first switch into the off-state, thereafter switch the third switch, thereafter switch the fourth switch into the off-state, and thereafter switch the fifth switch into the off-state.

8. The power supply device according to claim 5, wherein
the power converter circuit includes a third switch having a terminal of a body diode on an anode side connected to the first switch, and
the controller is configured to switch the first switch into the off-state, thereafter switch the fifth switch, thereafter switch the fourth switch into the off-state, and thereafter switch the third switch into an off-state.

9. The power supply device according to claim 6, wherein the controller is configured to provide a specified period of time after the switching of the third switch and the fifth switch into the off-state and before the switching of the fourth switch into the off-state.

10. The power supply device according to claim 1, wherein the second switch is one bidirectional switch.

11. The power supply device according to claim 1, wherein the second switch includes a bipolar transistor.

12. The power supply device according to claim 1, further comprising a direct-current power supply.

13. The power supply device according to claim 6, wherein
a period of time from the switching of the third switch and the fifth switch into the off-state to the switching of the fourth switch into the off-state is longer than a period of time from the switching of the first switch into the off-state to the switching of the third switch and the fifth switch into the off-state.

14. The power supply device according to claim 13, wherein
the period of time from the switching of the third switch and the fifth switch into the off-state to the switching of the fourth switch into the off-state is longer than or equal to 1 millisecond and shorter than 100 milliseconds.

15. The power supply device according to claim 6, wherein
a period of time from the switching of the third switch and the fifth switch into the off-state to the switching of the fourth switch into the off-state is shorter than a period of time from the switching of the first switch into the off-state to the switching of the third switch and the fifth switch into the off-state.

16. The power supply device according to claim 15, wherein
the period of time from the switching of the third switch and the fifth switch into the off-state to the switching of the fourth switch into the off-state is shorter than 1 millisecond or longer than 100 milliseconds.

17. The power supply device according to claim 1, wherein the controller includes a Microcontroller Unit (MCU).

18. The power supply device according to claim 1, wherein the controller includes a storage device and an arithmetic processing device.

19. The power supply device according to claim 17, the controller includes a first MCU configured to control the first switch and a second MCU configured to control the second switch.

20. A non-transitory computer readable medium storing a program which when executed by a computer causes the computer to perform a method, the method comprising:
switching a first switch into off-state, the first switch being placed between an input terminal of a power supply device to which a direct-current power supply can be connected and a power converter circuit placed between the input terminal and an output terminal of the power supply device; and
thereafter switching a second switch into off-state, the second switch being placed between the power converter circuit and the output terminal.
